(19) United States
(12) Patent Application Publication
(10) Pub. No.: US 2018/0330863 A1
(43) Pub. Date: Nov. 15, 2018

(54) FLUID-COOLED ELECTROMAGNETS

(71) Applicant: Korea Research Institute of Standards and Science, Daejeon (KR)

(72) Inventors: Seong-min Hwang, Daejeon (KR); Jeong-Hyun Shim, Daejeon (KR); Ingo Hilschenz, Daejeon (KR); Seong-Joo Lee, Daejeon (KR); Kiwoong Kim, Daejeon (KR)

(21) Appl. No.: 15/966,904

(22) Filed: Apr. 30, 2018

(30) Foreign Application Priority Data
May 12, 2017 (KR) 10-2017-0059235

(51) Int. Cl. H01F 27/10; H01F 7/06; H01F 27/22

(52) U.S. Cl. CPC H01F 27/10; H01F 27/22; H01F 7/06

(57) ABSTRACT

An electromagnet includes insulating cooling plates of a ceramic material which are vertically arranged parallel to each other, washer-shaped insulating center spacers maintained at a constant distance between adjacent insulating cooling plates, pancake coils including Litz wires which are spirally wound on each of the insulating center spacers in the space between the adjacent insulating cooling plates, and a housing which covers at least outer side surfaces of the insulating cooling plates and the pancake coils and provides a coolant to cool the insulating cooling plates.

### CROSS-REFERENCE TO RELATED APPLICATION

This U.S. non-provisional patent application claims priority under 35 U.S.C. § 119 to Korean Patent Application No. 10-2017-0059235, filed on May 12, 2017, in the Korean Intellectual Property Office, the entire contents of which are hereby incorporated by reference.

### TECHNICAL FIELD

The present disclosure relates to electromagnets and, more particularly, to a fluid-cooled electromagnet for generating a pre-polarization magnetic field for effectively generating a strong magnetic field and complete removal thereof.

### BACKGROUND

Conventional pre-polarization magnetic field coils are classified into small solenoid-type air-cooled coils, liquid nitrogen cooled coils, and water-cooled coils.

A small solenoid-type air-cooled coil is easily manufactured and widely used due to its simple structure. However, the small solenoid-type air-cooled coil suffers from the disadvantages that a volume capable of applying a pre-polarization magnetic field is very small, generatable pre-polarization magnetic field is limited to about 10 milliteslas (mT), and long-term use of the small solenoid-type air-cooled coil is difficult due to the lack of an effective cooling method.

A liquid nitrogen cooled coil reduces its own temperature with liquid nitrogen with boiling point of 77 K to reduce an electrical resistance to about one-eighth of room temperature and promote fast and effective coil cooling from boiling of the liquid nitrogen. A Dewar for the coil is required to contain the cooling liquid nitrogen. It is costly to manufacture a Dewar due to its complexity and difficulty in making of it. Since the Dewar represents a large proportion of weight and volume, the volume capable of applying a pre-polarization magnetic field is reduced correspondingly. Even with a high-performance Dewar, it is necessary to fill the Dewar with cooling liquid nitrogen periodically, making it inconvenient.

A water-cooled coil (including the case where a cooling oil such as mineral oil, silicone oil or fluoride compound is used as a coolant) cools a coil with a typical coolant such as water, mineral oil or silicone oil that is used at room temperature. Since a difference between internal and external temperatures of an enclosure covering a coil is small and the enclosure has only to withstand an internal pressure required to circulation of a coolant, it is relatively easy to fabricate the enclosure. When the conducting wire of a coil is a Litz wire, a space through which the coolant can pass should be formed in the coil. Thus, winding becomes complex and effective current density is reduced correspondingly. When a copper pipe allowing the coolant to flow to its center is used as the conducting wire of the coil, a circulation structure of the coolant is simplified and loss of the effective current density is reduced. However, the bulk of the conducting wire generates significant amount of thermal noise.

### SUMMARY

Example embodiments of the present disclosure provide a fluid-cooled electromagnet that operates at room temperature and eliminates thermal noise, which overcomes disadvantages of a conventional water-cooled electromagnet.

An electromagnet according to an example embodiment of the present disclosure includes: a plurality of insulating cooling plates of a ceramic material which are vertically arranged parallel to each other; a plurality of washer-shaped insulating center spacers maintained at a constant distance between adjacent insulating cooling plates; a plurality of pancake coils including Litz wires which are spirally wound on each of the insulating center spacers in a space between the adjacent insulating cooling plates; and a housing which covers at least outer side surfaces of the insulating cooling plates and the pancake coils and provides a coolant to cool the insulating cooling plates. The Litz wires constituting the pancake coils may be in thermal contact with the adjacent insulating cooling plates. The coolant may be provided in a cooling space. The cooling space may be formed in a space which is not filled with the insulating center spacers and the pancake coils in a space between the adjacent insulating cooling plates.

In example embodiments, each of the pancake coils may include a plurality of unit pancake coils stacked to be aligned with each other. Each of the unit pancake coils is spirally wound on the same plane. Directions in which the unit pancake coils are wound may be identical to each other in the same pancake coil. The unit pancake coils may be electrically connected in series in the same pancake coil. The adjacent unit pancake coils are in thermal contact with each other.

In example embodiments, among the pancake coils, the lowermost pancake coil may include a first connection terminal for electrical connection with an external power supply. Among the pancake coils, the uppermost pancake coil may include a second connection terminal for electrical connection with the external power supply. The pancake coils may be connected in series to each other according to layer height. Directions in which Litz wires constituting the pancake coils are wound may be alternately opposite to each other according to layer height of the pancake coils.

In example embodiments, at least two adjacent pancake coils may constitute a pancake coil bundle. Pancake coils constituting each of the pancake coil bundles may be connected in parallel to each other. Among the pancake coil bundles, the lowermost pancake coil bundle may include a first connection terminal disposed at one of its opposite ends for electrical connection with an external power supply. Among the pancake coil bundles, the uppermost pancake coil bundle may include a second connection terminal disposed at one of its opposite ends for electrical connection with an external power supply. The pancake coil bundles may be sequentially connected in series to each other according to layer height. Directions in which Litz wires of the pancake coils constituting the pancake coil bundles may be wound are alternately opposite to each other according to layer height.

In example embodiments, the cooling space may be formed at the outermost position between adjacent insulating cooling plates. The outer diameters of the insulating cooling plates may be greater than that of the pancake coils. The housing may include: a cylindrical housing body portion which includes a washer-shaped bottom support disposed on its bottom surface and stores the insulating cooling plates and the pancake coils; a housing cover portion which has a circular washer shape and is disposed to cover the top surface of the housing body portion; a coolant inlet which connects the cooling space with the outside of the housing through one of the side surface, the bottom surface, and the top surface of the housing body portion; a coolant outlet which connects the cooling space with the outside of the housing through one of the side surface, the bottom surface, and the top surface of the housing body portion; and a separator which barricades the space between the coolant inlet and the coolant outlet in the cooling space.

In example embodiments, each of the insulating cooling plates may have a through-hole formed in its center. The insulating center spacers may be inserted between through-holes of adjacent insulating cooling plates to be fixed, respectively.

In example embodiments, an alignment protrusion may be provided between the bottom support and a bottom inner side surface of the housing body portion.

In example embodiments, the number of the pancake coils may be odd. Among the pancake coils, the lowermost pancake may include a first connection terminal for electrical connection with an external power supply. Among the pancake coils, the uppermost pancake coil may include a second connection terminal for electrical connection with the external power supply. The pancake coils may be connected in series to each other according to layer height.

Directions in which Litz wires constituting the pancake coils are wound may be opposite to each other according to layer height of the pancake coils. One of the first and the second connection terminals may be disposed to pass through the insulating center spacer, and the other of the first and the second connection terminals may be disposed to penetrate the housing.

In example embodiments, the cooling space may be formed at an outermost position between adjacent insulating cooling plates. The outer diameter of the insulating cooling plates may be greater than that of the pancake coils. The housing may include: a cylindrical housing body portion which includes a disk-shaped bottom support disposed on its bottom surface and stores the insulating cooling plates and the pancake coils; a housing cover portion which has a disk shape and is disposed to cover the top surface of the housing body portion; a coolant inlet which connects the cooling space with the outside of the housing through one of the side surface, the bottom surface, and the top surface of the housing body portion; a coolant outlet which connects the cooling space with the outside of the housing through one of the side surface, the bottom surface, and the top surface of the housing body portion; and a separator which blocks between the coolant inlet and the coolant outlet in the cooling space.

In example embodiments, the insulating cooling plates may include disk-shaped first insulating cooling plates and circular washer-shaped second insulating cooling plates each having a through-hole formed in its center. The first insulating cooling plates and the second insulating cooling plates may be alternately disposed according to layer height. The first insulating cooling plates may be disposed on the uppermost surface and on the lowermost surface.

In example embodiments, each of the insulating cooling plates may have a through-hole formed in its center. Each of the insulating center spacers may have a circular washer shape. The inner diameter of the insulating spacers may be greater than the diameter of the through-holes of the insulating cooling plates. The outer diameter of the insulating cooling plates may be greater than that of the pancake coils. The cooling space may include a first cooling space formed between adjacent insulating cooling plates at the outermost positions and a second cooling space formed between the adjacent insulating cooling plates at the innermost positions. The housing may be in the form of a hollow toroid having a square section. The housing may include: a coolant inlet which connects the cooling space with the outside of the housing through one of the outer side surface, the bottom surface, and the top surface of the housing; a coolant outlet which connects the cooling space with the outside of the housing through one of the outer side surface, the bottom surface, and the top surface of the housing; a first separator which barricades the space between the coolant inlet and the coolant outlet; first and second flow passages which are formed on the bottom surface of the housing to be adjacent to each other in a radial direction to connect the first cooling space and the second cooling space to each other; a second separator which locally barricades the first cooling space; and a third separator which locally barricades the second cooling space such that a coolant flows into the first flow passage to flow out of the second flow passage. The coolant may flow along a portion of the first cooling space, the first flow passage, the second cooling space, the second flow passage, and the other portion of the first cooling space.

In example embodiments, each of the insulating cooling plates may have a through-hole formed in its center. Each of the insulating center spacers may have a circular washer shape. The inner diameter of the insulating center spacers may be greater than the diameter of the through-holes of the insulating cooling plates. The outer diameter of the insulating cooling plates may be greater than that of the pancake coils. The cooling space includes a first cooling space formed between adjacent insulating cooling plates at the outermost positions and a second cooling space formed between the adjacent insulating plates at the innermost positions. The housing may be in the form of a hollow toroid having a square section. The housing may include: a coolant inlet which connects the second cooling space with the outside of the housing through the bottom surface of the housing; a coolant outlet which connects the second cooling space with the outside of the housing through the bottom surface of the housing through one of the outer side surface, the bottom surface, and the top surface; a first separator which locally barricades the first cooling space; a flow passage which is formed on the bottom surface of the housing in a radial direction to connect the first cooling space and the second cooling space to each other; and a second separator which locally barricades the second cooling space. The coolant may flow along the second cooling space, the flow passage, and the first cooling space.

In example embodiments, the material of the insulating cooling plates may include at least one of aluminum nitride (AlN), alumina (Al₂O₃), boron nitride (BN), silicon nitride (Si₃N₄), and beryllium oxide (BeO).

An electromagnet according to another example embodiment of the present disclosure includes: a plurality of insulating cooling plates of a ceramic material which are vertically arranged parallel to each other; a plurality of washer-shaped insulating center spacers which are formed of a non-metal material and are maintained at a constant distance between adjacent insulating cooling plates; a plurality of pancake coils including Litz wires which are spirally wound on each of the insulating center spacers in a space between the adjacent insulating cooling plates; and a housing which stores the insulating cooling plates and the pancake coils and provides a coolant to cool the insulating cooling plates. The pancake coils may be in thermal contact with the adjacent insulating cooling plates. The coolant may be provided in a cooling space in which the insulating cooling plates are exposed. The cooling space may be formed in the space between the adjacent insulating cooling plates not filled with the insulating center spacers and the pancake coils.

An electromagnet according to an example embodiment of the present disclosure includes: a plurality of insulating cooling plates of a ceramic material which are vertically arranged parallel to each other; a plurality of washer-shaped insulating center spacers maintained at a constant distance between adjacent insulating cooling plates; a plurality of pancake coils including Litz wires which are spirally wound on each of the insulating center spacers in the space between the adjacent insulating cooling plates; and a housing which is in the form of a toroid having a square section, stores the insulating cooling plates and the pancake coils, and provides a coolant to cool the insulating cooling plates. The Litz wires constituting the pancake coils may be in thermal contact with the adjacent insulating cooling plates. The coolant may be provided in a cooling space.

### BRIEF DESCRIPTION OF THE DRAWINGS

The present disclosure will become more apparent in view of the attached, example drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the present disclosure.

FIG. 1 is a perspective view of an electromagnet according to an example embodiment of the present disclosure.

FIG. 2 is a perspective view of a housing body portion of the electromagnet in FIG. 1.

FIG. 3 is a perspective view of a pancake coil module inserted into a housing of the electromagnet in FIG. 1.

FIG. 4 is a cross-sectional view of the pancake coil module in FIG. 3.

FIGS. 5A and 5B are a top plan view of the electromagnet in FIG. 1 and a cross-sectional view taken along the line A-A′, respectively.

FIG. 6 is a perspective view of an insulating center spacer of the electromagnet in FIG. 6.

FIG. 7 illustrates an electric connection relationship between pancake coils constituting the electromagnet in FIG. 1.

FIG. 8 illustrates circulation of a coolant and time-dependent variation of a coil resistance when a current is applied to an electromagnet for pre-polarization according to an example embodiment of the present disclosure.

FIG. 9 illustrates a theoretical thermal analysis result according to a computer simulation and a test-run measurement of a prototype electromagnet built according to an example embodiment of the present disclosure.

FIG. 10 is a simulation result illustrating temperature variations depending on width of a cooling space in radial direction of the pancake coil module.

FIG. 11 is a cross-sectional view of an electromagnet according to another example embodiment of the present disclosure.

FIG. 12 illustrates an electrical connection relationship between pancake coils of the electromagnet in FIG. 11.

FIG. 13 is a cross-sectional view of an electromagnet according to another example embodiment of the present disclosure.

FIG. 14 is a cross-sectional view of an electromagnet according to another example embodiment of the present disclosure.

FIG. 15 is a conceptual diagram of an electromagnet according to another example embodiment of the present disclosure.

FIG. 16A is a top plan view of an electromagnet according to another example embodiment of the present disclosure.

FIG. 16B is a cross-sectional view taken along the line B-B′ in FIG. 16A.

FIG. 16C is a cross-sectional view taken along the line C-C′ in FIG. 16A.

FIG. 17A is a top plan view of an electromagnet according to another example embodiment of the present disclosure.

FIG. 17B is a cross-sectional view taken along the line D-D′ in FIG. 17A.

FIG. 17C is a cross-sectional view taken along the line E-E′-E″ in FIG. 17A.

### DETAILED DESCRIPTION

An ultra-low field nuclear magnetic resonance/magnetic resonance imaging (ULF-NMR/MRI) system uses a superconducting quantum interference device (SQUID) which is capable of measuring a magnetic field of a few fT. In the ULF-NMR/MRI system, a SQUID sensor senses a low-frequency nuclear magnetic resonance (NMR) signal. Although a strong pre-polarization magnetic field is required, there are problems in the generation of the strong pre-polarization magnetic field. The intensity of an NMR signal depends on the magnitude and duration of the pre-polarization magnetic field. The pre-polarization magnetic field requires the magnitude of 10 mT or more, a fast ramping-down time of 10 msec or less, and a negligible amount of residual magnetic field after ramping down.

The ULF-NMR/MRI system requires a pre-polarization coil (Bp coil) which is capable of generating a strong pre-polarization magnetic field and completely removing the same pre-polarization magnetic field rapidly.

Since a pre-polarization magnetic field Bp should be removed completely and rapidly, the pre-polarization magnetic field requires following characteristics. First, all materials constituting the coil should be free of magnetism. Second, eddy current generated should be negligible when the pre-polarization magnetic field Bp is generated or is removed. If eddy current is generated, its life-time should be shorter than a ramping-down time of the pre-polarization magnetic field Bp (10 ms or less). Third, thermal noise generated from the coil should be low enough to have no influence on detection of the magnetic resonance signal. Fourth, since an induced electromotive force of hundreds to thousands of volts is generated when the pre-polarization magnetic field Bp is generated or is removed, a coil generating the pre-polarization Bp should be designed to withstand the induced electromotive force. Fifth, since a large amount of current flows to a coil when the pre-polarization magnetic field Bp is generated, electrical resistance of the coil should be minimized to reduce ohmic heating. In addition, an effective coil cooling method is required to limit temperature rise of the coil which results from the generated heat.

A fluid-cooled electromagnet according to an example embodiment of the present disclosure includes a pre-polarization coil that can rapidly generate a strong magnetic field of about 0.1 T and completely remove the same. A ceramic sheet material (made of one or more of materials including AlN and AlO₂), with a high thermal conductivity and a high electrical resistivity, is used as an internal structure to effectively cool the interior of the pre-polarization coil. Water, mineral oil, silicone oil or a fluoride compound is used as coolant to cool the ceramic sheet material.

Example embodiments will now be described more fully with reference to the accompanying drawings, in which some example embodiments are shown. Example embodiments may, however, be embodied in many different forms and should not be construed as being limited to the embodiments set forth herein; rather, these example embodiments are provided so that this disclosure will be thorough and complete, and will fully convey the scope of example embodiments of the present disclosure to those of ordinary skill in the art. In the drawings, the thicknesses of layers and regions are exaggerated for clarity. Like reference characters and/or numerals in the drawings denote like elements, and thus their description may be omitted.

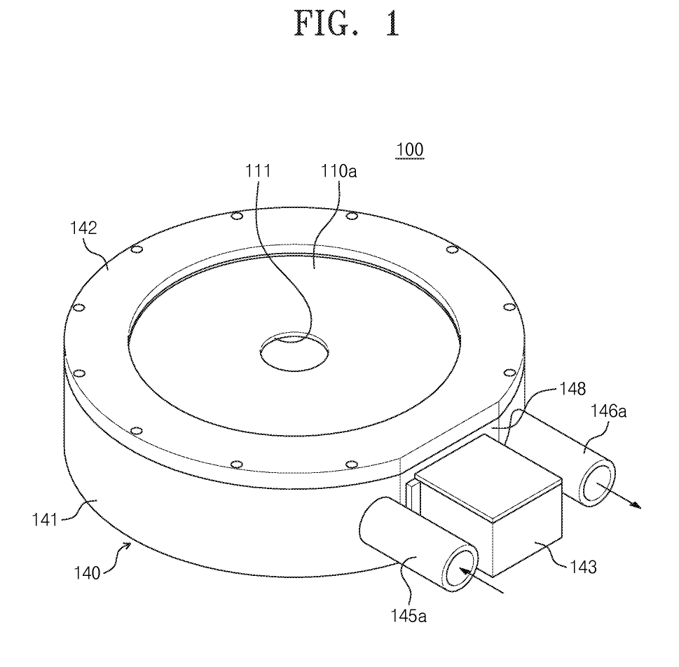

FIG. 1 is a perspective view of an electromagnet according to an example embodiment of the present disclosure.

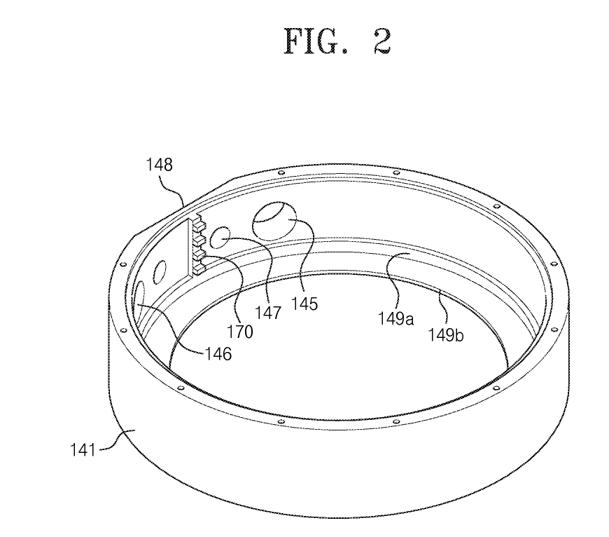

FIG. 2 is a perspective view of a housing body portion of the electromagnet in FIG. 1.

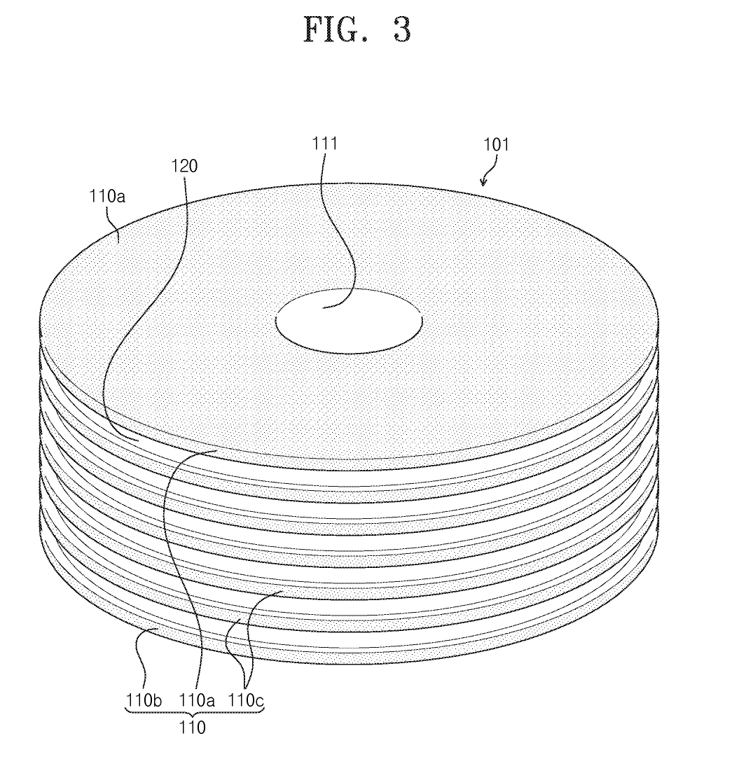

FIG. 3 is a perspective view of a pancake coil module inserted into a housing of the electromagnet in FIG. 1.

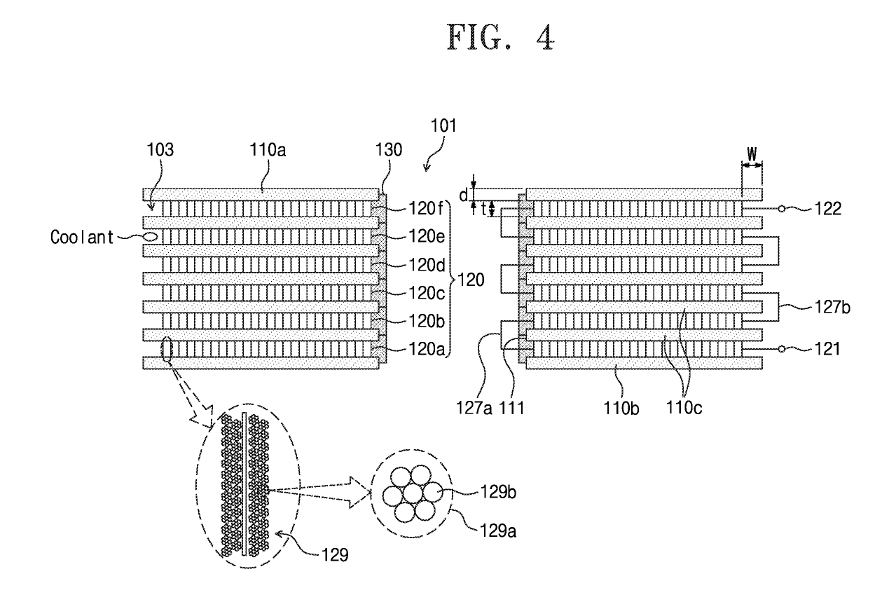

FIG. 4 is a cross-sectional view of the pancake coil module in FIG. 3.

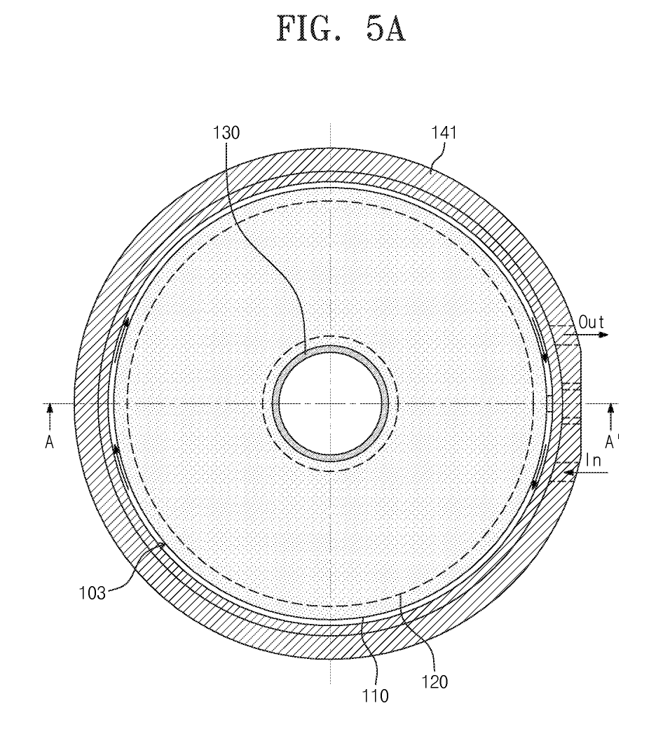

FIGS. 5A and 5B are a top plan view of the electromagnet in FIG. 1 and a cross-sectional view taken along the line A-A′, respectively.

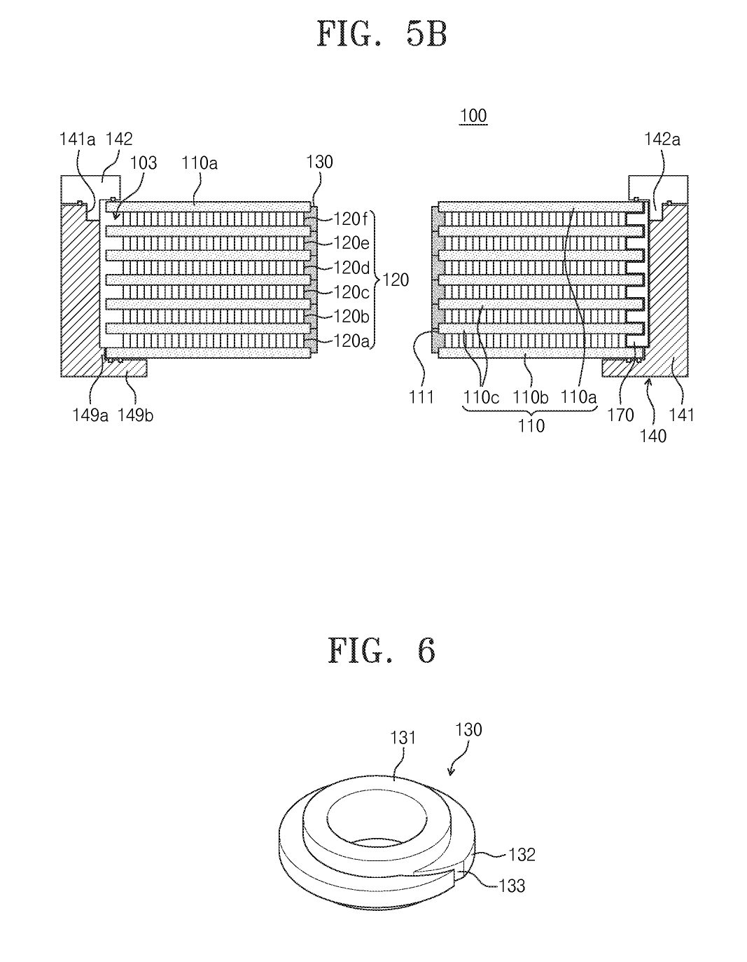

FIG. 6 is a perspective view of an insulating center spacer of the electromagnet in FIG. 6.

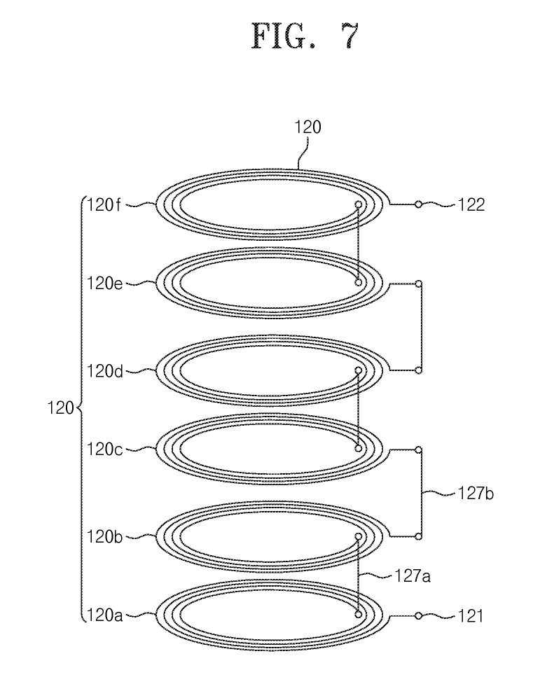

FIG. 7 illustrates an electric connection relationship between pancake coils constituting the electromagnet in FIG. 1.

Referring to FIGS. 1 through 7, an electromagnet 100 includes a plurality of insulating cooling plates 110 of a ceramic material which are vertically arranged parallel to each other; a plurality of washer-shaped insulating center spacers 130 maintained at a constant distance between adjacent insulating cooling plates 110; a plurality of pancake coils 120 including Litz wires 129 which are spirally wound on each of the insulating center spacers 130 in the space between the adjacent insulating cooling plates 110; and a housing 140 which covers at least outer side surfaces of the insulating cooling plates 110 and the pancake coils 120 and provides a coolant to cool the insulating cooling plates 110. The Litz wires 129 constituting the pancake coils 120 are in thermal contact with the adjacent insulating cooling plates 110. The coolant is provided in a cooling space 103, and the cooling space 103 is formed in a space which is not filled with the insulating center spacers 130 and the pancake coils 120 in a space between the adjacent insulating cooling plates 110.

The insulating cooling plates 110 include a top insulating cooling plate 110a, a bottom insulating cooling plate 110b disposed to be perpendicular to the top insulating cooling plate 110a, and at least one intermediate insulating cooling plate 110c that is disposed to be perpendicular to the top insulating cooling plate 110a, has a through-hole 111 formed in its center, and is interposed between the top insulating cooling plate 110a and the bottom insulating cooling plate 110b. The insulating cooling plates 110 may have the same circular washer shape and have through-holes 111 in their centers.

The insulating center spacers 130 is inserted into the through-holes 111 of the insulating cooling plates 110 to be maintained at a constant distance between adjacent insulating cooling pates 110 and has a ring shape.

The pancake coils 120 include the Litz wires 129 which are spirally wound on each of the insulating center spacers 130 in the space between the adjacent insulating cooling plates 110.

The housing 140 is disposed to cover at least outer side surfaces of the insulating cooling plates 110 and the pancake coils 120 and provides a coolant to cool the insulating cooling plates 110. The coolant may cool the periphery of outer circumferential surfaces of the insulating cooling plates 110.

The pancake coils 120 may be sequentially connected in series to each other according to layer height. The number of the pancake coils 120 may be even or odd. The pancake coils 120 are alternately wound in opposite directions to each other according to layer height. The Litz wire 129 constituting the pancake coil 120 may have a rectangular section. Each of the pancake coils 120a to 120f may be molded by a thermally conductive epoxy. The Litz wire 129 constituting the pancake coil 120 may be fixed by the epoxy while being wound. The pancake coils 120 may be sealed by the epoxy to be fixed to the adjacent insulating cooling plates 110.

Among the pancake coils 120, the lowermost pancake coil 120a includes a first connection terminal 121 disposed at its outermost position for electrical connection with an external power supply and the uppermost pancake coil 120f may include a second connection terminal 122 disposed at its outermost position for electrical connection with the external power supply. The pancake coils 120 may be sequentially connected in series to each other according to layer height, the number of the pancake coils 120 is even, and the pancake coils 120 may be alternately wound in opposite directions to each other according to the layer height.

The plurality of insulating cooling plates 120, the insulating center spacers 130, and the pancake coils 120 may be molded to each other by an epoxy adhesive to constitute a pancake coil module 101. The pancake coil module 101 may be inserted into the housing 140 to be cooled by a coolant. The coolant may flow along a cooling space 103 exposed around an outer radius where an inter side surface of the housing 140 and the adjacent insulating cooling plates 110 face each other. To provide the cooling space 103, an outer radius of the insulating cooling plate 110 may be greater than that of the pancake coil 120.

The coolant may flow along the cooling space 103, and the cooling space 103 may be formed in the space between the adjacent insulating cooling plates 110 at the outermost positions not filled with the pancake coil 120. The top insulating cooling plates 110a, the intermediate insulating cooling plate 110b, and the bottom insulating cooling plates 110b may have the same shape and be parallel to each other and aligned perpendicularly.

When a current flows to the pancake coil 120, heat generated by Joule heating may be transferred to the insulating cooling plates 110 disposed on top and bottom surfaces of the pancake coil 120, the transferred heat may be transferred in a radial direction of the insulating cooling pates 110, and the heat transferred to the periphery of the outer radius may be transferred to the coolant. The coolant may be forcibly circulated through a pump, and heat of the coolant taken out of the housing 140 may be removed through a heat exchanger disposed at the outside. The coolant may be maintained at constant temperature. The coolant may be water, mineral oil, silicone oil or a fluoride compound.

The insulating cooling plates 110 may be formed of an insulating ceramic, and thermal conductivity of the insulating cooling plates 110 may be 10 W/m-K or higher to achieve effective heat transfer. The insulating cooling plates 110 may include at least one of aluminum nitride (AlN), sapphire, alumina (Al₂O₃), silicon nitride (Si₃N₄), boron nitride (BN), and beryllium oxide (BeO). Preferably, the insulating cooling plates 110 may include aluminum nitride (AlN) having thermal conductivity of 150 W/m-K or higher. Thickness of the insulating cooling plates 110 may be between 2 and 3 mm. The difference between the outer diameter of the insulating cooling plates and the outer diameter of the pancake coils 120, which provide the cooling space 103, may range from 3 mm to 7 mm.

The insulating center spacers 130 may be in the form of a ring having a square section, and the height of the insulating center spacers 130 may be greater than the thickness t of the pancake coils 120 and smaller than the total thickness of one of the pancake coil 120 and two of the insulating cooling plates 110 (t+2d). The insulating center spacers 130 may be formed of plastic having electrically insulating properties. Each of the insulating center spacers 130 includes a first region 131 having a first thickness to be inserted into the through-hole 111 of the insulating cooling plate 110 and a second region 132 having a second thickness disposed between a pair of the insulating cooling plates 110 to be maintained at a constant distance. The first thickness is greater than the second thickness. Each of the insulating center spacers 130 may have a spiral gap 133 formed in a direction in which azimuthal angle increases as radius increases in the second region. The Litz wire 129 may be connected to the pancake coils 120 through the spiral gaps 133.

The pancake coils 120 may be aligned to be perpendicular to one another, be stacked at regular intervals, and have the same structure. Each pair of the adjacent pancake coils 120 are connected in series to each other to generate magnetic fields in the same direction. Each pair of the adjacent pancake coils 120 are wound in opposite directions to each other. Thus, connection portions of adjacent pancake coils 120 are aligned in a reciprocally perpendicular position, and a current flowing to the pancake coils 120 generally flows in a direction of the same azimuthal direction.

The number of windings of each of the pancake coils 120 may be about 75 on the same plane. A Litz wire constituting the pancake coil 120 may have a square section. The Litz wire may have nine bottom bundles and eight top bundles disposed on the bottom bundles. Each bundle 129a may include seven copper conducting wires 129b coated with an insulator.

The lowermost pancake coil 120a includes a first connection terminal 121 disposed at its outermost position for electrical connection with an external power supply. Among the pancake coils 120a, the uppermost pancake coil 120f includes a second connection terminal 122 disposed at its outermost position for electrical connection with the external power supply. Adjacent pancake coils 120a may be connected to each other through their inner connection portions 127a formed of a Litz wire perpendicular to a disposition plane around its inner radius. Adjacent pancake coils 120a may be connected to each other through their outer connection portions 127b formed of a Litz wire perpendicular to a disposition plane around its outer radius. The inner connection portion 127a or the outer connection portion 127b may be connected through soldering with silver solder.

The cooling space 103 may be formed between adjacent insulating cooling plates 110 at the outermost positions, and the outer diameter of the insulating cooling plates 110 may be greater than that of the pancake coils 120. The inner diameter of the insulating cooling plates 110 may be smaller than that of the pancake coils 120. Each of the insulating cooling plates 110 may have a through-hole formed in its center, and the insulating center spacers 130 may be inserted between the through-holes of adjacent insulating cooling plates to be fixed, respectively.

The housing 140 may include a cylindrical housing body portion 141 which includes a circular washer-shaped bottom support 149b disposed on its bottom surface and stores the insulating cooling plates 110 and the pancake coils 120, a housing cover portion 142 which has a circular washer shape and is disposed to cover the top surface of the housing body portion 141, a coolant inlet 145 which connects the cooling space 103 with the outside of the housing 140 through a side surface of the housing body portion 141, a coolant outlet 146 which connects the cooling space 103 with the outside of the housing 140 through the side surface of the housing body portion 141, and a separator 170 which barricades the space between the coolant inlet 145 and the coolant outlet 146 in the cooling space 103. The housing 140 may include a ring-shaped alignment protrusion 149a between the bottom support 149b and a bottom inner side surface of the housing body portion 141.

A connection box 143 may be disposed on a coupling surface 148 formed on the side surface of the housing body portion 141 and may electrically connect the first connection terminal 121 and the second connection terminal 122 to the outside. A normal line of the coupling surface 148 may be a radial direction of the housing body portion 141. The housing 140 may be formed of an electrical insulator such as plastic. The housing 140 may seal the pancake coil module 101 with sealing means such as an O-ring. Thus, a coolant provided to the housing 140 may flow along the cooling space 103 without leaking.

The housing body portion 141 may be cylindrical and may be formed of an insulating material such as a plastic. The ring-shaped bottom support 149b may be provided on a bottom surface of the housing body portion 141. The bottom support 149b may support the pancake coil module 101. The alignment protrusion 149a is protrusive and is provided at the corner between the lower inner surface of the housing body portion 141 and the bottom support 149b. The alignment protrusion 149a may align the pancake coil module 101.

A top surface of the housing body portion 141 may include a depressed portion which is depressed around its inner side surface. The depressed portion 141a may be coupled with a protrusion 142a protruding from a bottom surface of the housing cover portion 142 to align the housing cover portion 142.

The housing cover portion 142 may have a circular washer shape that pushes on a top outer circumferential surface of the pancake coil module 101. The housing cover portion 142 may be formed of a plastic.

A portion of an outer side surface of the housing body portion 141 may include a coupling surface 148. The coupling surface 148 is a plane, and a normal direction of the coupling surface 148 may be a radial direction of the housing body portion 141.

The connection box 143 may have a rectangular shape and be coupled with the coupling surface 148 to be fixed. A connection portion for electrical connection to an external current supply may be disposed at the connection box 143. The connection box 143 may be in the form of a hollow box and have a through-hole for an input line and an output line of the pancake coil module 101. A through-hole 147 formed on the coupling surface 148 may be continuously connected to the through-hole of the connection box 143. The connection box 143 may electrically connect the first connection terminal 121 and the second connection terminal 122 to an external power supply. The connection box 143 may be formed of a plastic. The connection box 143 may have a cover.

The coolant inlet 145 may be formed on the side surface of the housing body portion 141, and the coolant outlet 146 may be formed on the side surface of the hosing body portion 141. The coolant inlet 145 may be connected to the coolant inflow line 145a, and the coolant outlet 146 may be connected to a coolant outflow line 146a.

The separator 170 may be disposed on an inner side surface of the housing body portion 141 between the coolant inlet 145 and the coolant outlet 146. The separator 170 may locally fill a gap between the inner side surface of the housing body portion 141 and the outer side surface of the pancake module 101. The separator 170 may barricade a fluid passage to prevent the coolant from rotating in a certain radial direction. The separator 170 may extend in a height direction of the housing body portion 141 and have a protrusion protruding in an inner radial direction to be locally inserted into the cooling space 103. The separator 170 may be fixed to the housing body portion 141 or formed in one body with the housing body portion 141.

The insulating cooling plates 110 formed of a ceramic with a high thermal conductivity may rapidly transfer heat generated in a pancake coil to the outside, the transferred heat may be transferred to a coolant, and the coolant may be circulated to stably cool the pancake coil to room temperature.

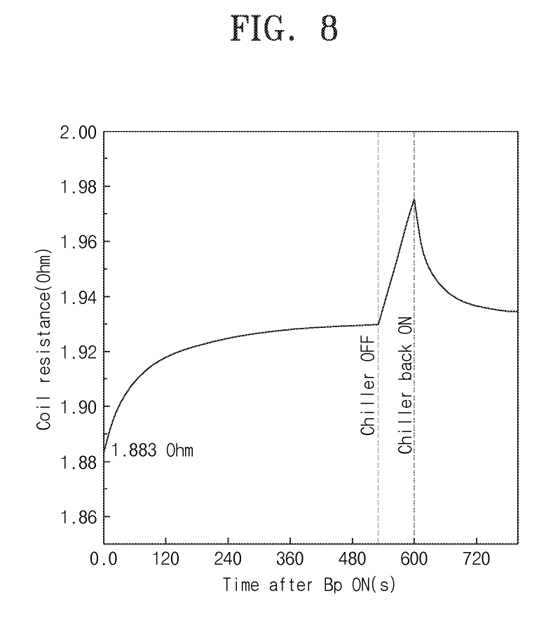

FIG. 8 illustrates circulation of a coolant and time-dependent variation of a coil resistance when a current is applied to the electromagnet for pre-polarization according to an example embodiment of the present disclosure.

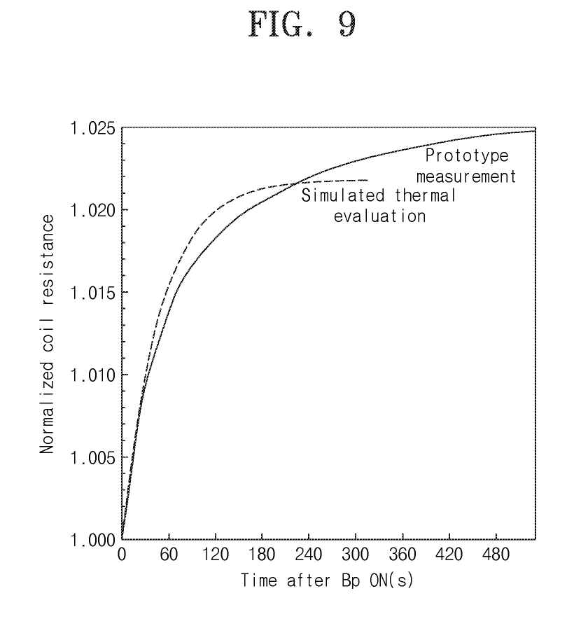

FIG. 9 illustrates a theoretical thermal analysis result according to a computer simulation and a test-run measurement of a prototype electromagnet built according to an example embodiment of the present disclosure.

Referring to FIGS. 8 and 9, an insulating cooling plate is formed of AIN with a thickness of 3 mm, the number of pancake coils is six, and the number of turns of each pancake coil ranges from 73 to 77. Thickness of each pancake coil is 3.6 mm, the inner diameter of the pancake coil is 34 mm, and the outer diameter of the pancake coil is 160 mm. The outer diameter of the insulating cooling plate is 170 mm.

Referring to FIG. 8, when a current of 12 A is applied to an electromagnet, a coil resistance increases with time to a saturation point. Circulation of coolant was stopped for one minute about nine minutes after the current was applied, after which the circulation of the coolant was restarted. The coil resistance rapidly increased for one minute with the circulation of the coolant stopped. Then, it has been confirmed that cooling is efficiently performed when the coolant is circulated again.

Referring to FIG. 9, a computer simulation theoretical thermal analysis result and an actual measurement result exhibit similar cooling performance (in terms of coil resistance characteristics).

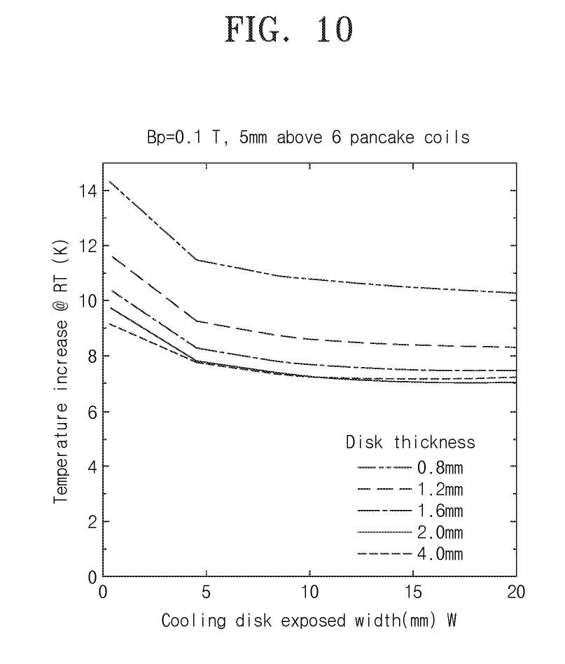

FIG. 10 is a simulation result illustrating temperature variations depending on width of a cooling space in radial direction of the pancake coil module.

Referring to FIG. 10, when a thickness of an insulating cooling plate per pancake coil, which is a module corresponding to a thickness of 3.2 mm of an actually applied insulating cooling plate, is 1.6 mm or more, efficient cooling is performed. When a width W of a radial direction of a cooling space is about 5 mm or more, efficient cooling is performed. On the other hand, when the width W of the radial direction of the cooling space increases too much, the number of turns of a coil may be relatively reduced and thus the magnitude of a magnetic field may be reduced compared with that when a current is applied. As a result, the width W of the radial direction of the cooling space may preferably range from 3 mm to 7 mm.

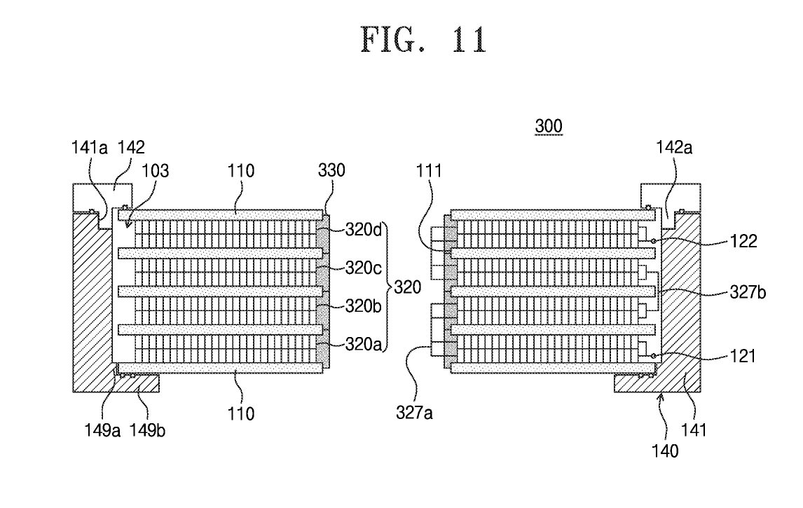

FIG. 11 is a cross-sectional view of an electromagnet according to another example embodiment of the present disclosure.

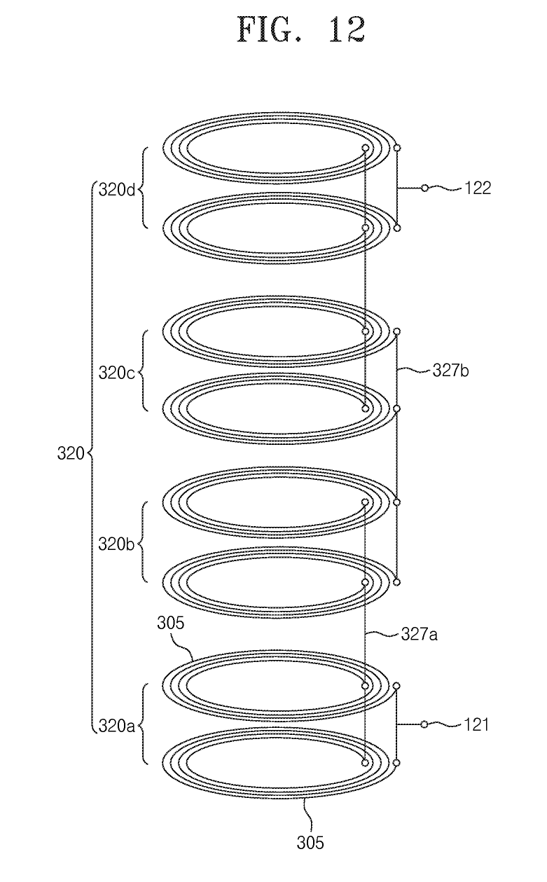

FIG. 12 illustrates an electrical connection relationship between pancake coils of the electromagnet in FIG. 11.

Referring to FIGS. 11 and 12, an electromagnet 300 includes a plurality of insulating cooling plates 110 of a ceramic material which are vertically arranged parallel to each other; a plurality of washer-shaped insulating center spacers 330 maintained at a constant distance between adjacent insulating cooling plates 110; a plurality of pancake coils 320 including Litz wires which are spirally wound on each of the insulating center spacers 330 in a space between the adjacent insulating cooling plates 110; and a housing 140 which covers at least outer side surfaces of the insulating cooling plates 110 and the pancake coils 320 and provides a coolant to cool the insulating cooling plates 110. The Litz wires constituting the pancake coils 320 are in thermal contact with the adjacent insulating cooling plates 110. The coolant is provided in a cooling space 103, and the cooling space 103 is formed in a space which is not filled with the insulating center spacers 330 and the pancake coils 320 in a space between the adjacent insulating cooling plates 110.

Each of the pancake coils 320a to 320d may include a plurality of unit pancake coils 305 which are aligned with each other to be stacked. Each of the unit pancake coils 305 is spirally wound in the same plane. Unit pancake coils 305 in a single pancake coil 320a may be electrically connected in parallel. Each of the unit pancake coils 305 may be spirally wound on the same plane. The pancake coils 320 may be sequentially connected in series to each other according to height. The pancake coils 320 may be alternately wound in opposite directions according to height to generate magnetic fields of the same direction. The number of the unit pancake coils 305 may be two or more in the same pancake coil. In the same pancake coil, the unit pancake coils 305 may be connected in parallel to each other. An inner connection portion 327b may connect the unit pancake coils 303 in parallel to each other and connect adjacent pancake coils in series to each other in the same pancake coil.

The insulating center spacers 330 may be inserted into a through-hole of the insulating cooling plate 110 to constantly maintain a distance of adjacent insulating cooling plates 110. The unit pancake coil 305 may be spirally wound on the insulating center spacers 330.

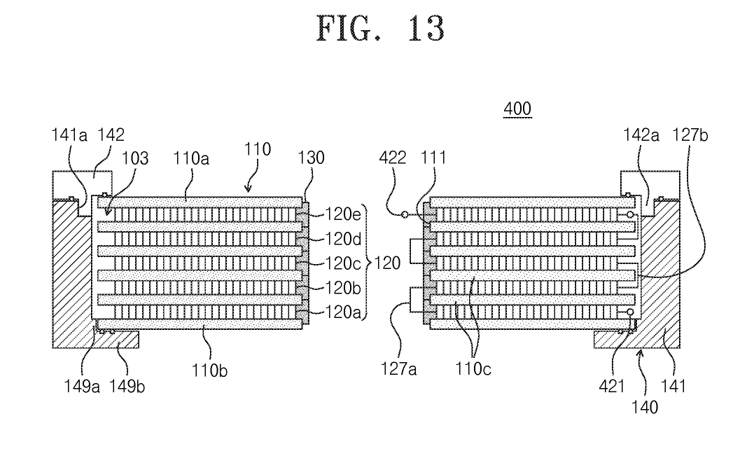

FIG. 13 is a cross-sectional view of an electromagnet according to another example embodiment of the present disclosure.

Referring to FIG. 13, an electromagnet 400 includes a plurality of insulating cooling plates 110 of a ceramic material which are vertically arranged parallel to each other; a plurality of washer-shaped insulating center spacers 130 maintained at a constant distance between adjacent insulating cooling plates 110; a plurality of pancake coils 120 including Litz wires which are spirally wound on each of the insulating center spacers 130 in a space between the adjacent insulating cooling plates 110; and a housing 140 which covers at least outer side surfaces of the insulating cooling plates 110 and the pancake coils 120 and provides a coolant to cool the insulating cooling plates 110. The Litz wires constituting the pancake coils 120 are in thermal contact with the adjacent insulating cooling plates 110. The coolant is provided in a cooling space 103, and the cooling space 103 is formed in a space which is not filled with the insulating center spacers 130 and the pancake coils 120 in a space between the adjacent insulating cooling plates 110.

The number of the pancake coils 120a to 120e may be odd. The pancake coils 120a to 120e may be alternately wound in opposite directions according to layer height.

The number of the pancake coils 120a to 120e may be odd. Among the pancake coils 120a to 120e, a lowermost pancake coil 120a may include a first connection terminal 421 for electrical connection with an external power supply and an uppermost pancake coil 120e may include a second connection terminal 422 for electrical connection with the external power supply. The pancake coils 120a to 120e may be sequentially connected in series to each other according to layer height, and directions in which the Litz wires constituting the pancake coils 120a to 120e may be opposite to each other according to layer height. One of the first and second connection terminals 421 and 422 may be disposed to pass through the insulating center spacer 130, and the other may be disposed to penetrate the housing 140.

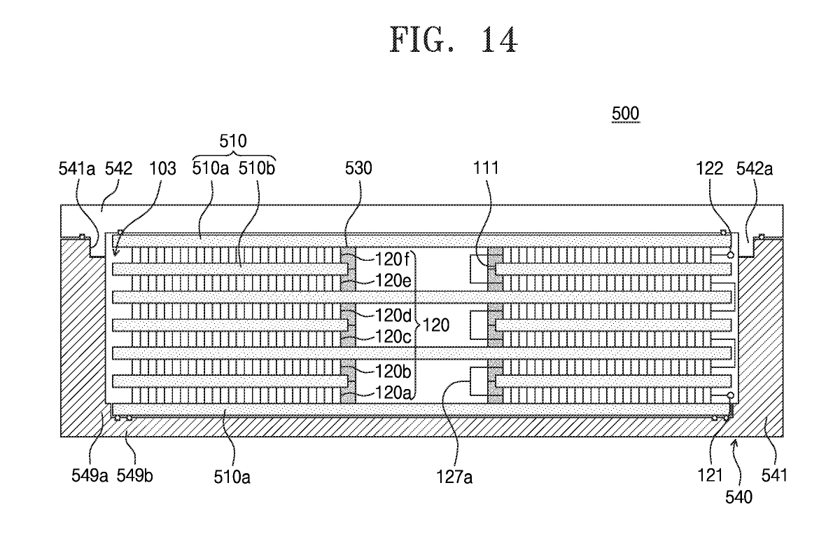

FIG. 14 is a cross-sectional view of an electromagnet according to another example embodiment of the present disclosure.

Referring to FIG. 14, an electromagnet 500 includes a plurality of insulating cooling plates 510 of a ceramic material which are vertically arranged parallel to each other; a plurality of washer-shaped insulating center spacers 530 maintained at a constant distance between adjacent insulating cooling plates 510; a plurality of pancake coils 120 including Litz wires which are spirally wound on each of the insulating center spacers 530 in a space between the adjacent insulating cooling plates 510; and a housing 540 which covers at least outer side surfaces of the insulating cooling plates 510 and the pancake coils 520 and provides a coolant to cool the insulating cooling plates 110. The Litz wires constituting the pancake coils 120 are in thermal contact with the adjacent insulating cooling plates 510. The coolant is provided in a cooling space 103, and the cooling space 103 is formed in a space which is not filled with the insulating center spacers 530 and the pancake coils 520 in a space between the adjacent insulating cooling plates 110.

The cooling space 103 may be formed at an outermost position between adjacent insulating cooling plates 510, and an outer diameter of the insulating cooling plate 510 may be greater than that of the pancake coil 120. The insulating cooling plates 510 may include disk-shaped first insulating cooling plates 510a and circular washer-shaped second insulating cooling plates 510b each having a through-hole 111 formed in its center. The first insulating cooling plates 510a and the second insulating cooling plates 510b may be alternately disposed according to layer height, and the first insulating cooling plates 510a may be disposed on an uppermost surface and a lowermost surface.

The housing 540 may include a cylindrical housing body portion 541 which includes a disk-shaped bottom support 549b disposed on its bottom surface and stores the insulating cooling plates 510 and the pancake coils 520, a housing cover portion 542 which has a disk shape and is disposed to cover the top surface of the housing body portion 541, a coolant inlet 145 which connects the coolant space 103 with the outside of the housing 540 through the side surface of the housing body portion 541, a coolant outlet 146 which connects the coolant space 103 with the outside of the housing 540 through the side surface of the housing body portion 541, and a separator 170 which barricades the space between the coolant inlet 145 and the coolant outlet 146 in the cooling space 103.

The insulating center spacers 530 are inserted into a through-hole 111 of each of the second insulating cooling plates 510b to be maintained at a constant distance between adjacent insulating cooling plates 510 and have a ring shape.

The pancake coils 120a to 120f include Litz wires which are spirally wound on each of the insulating center spacers 530 in a space between the adjacent insulating cooling plates 510. The housing 540 may store the insulating cooling plates 510 and the pancake coils 120 and provides a coolant to cool the insulating cooling plates 510.

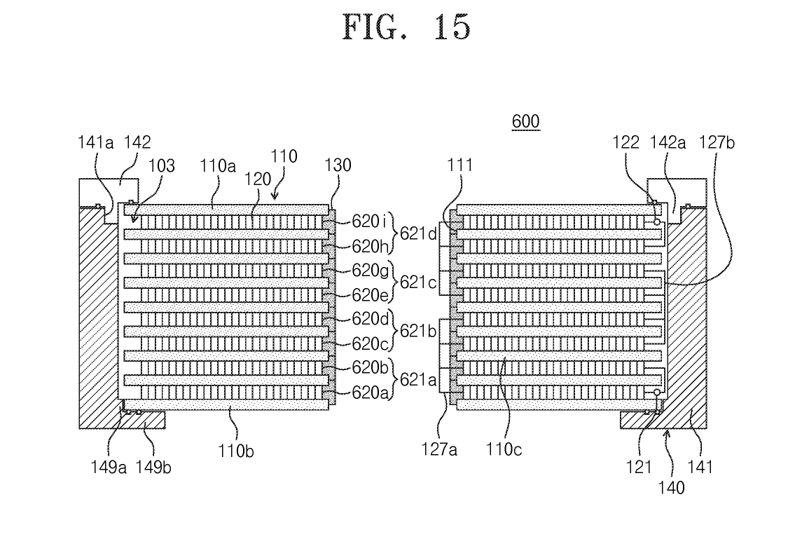

FIG. 15 is a conceptual diagram of an electromagnet according to another example embodiment of the present disclosure.

Referring to FIG. 15, an electromagnet 600 includes a plurality of insulating cooling plates 110 of a ceramic material which are vertically arranged parallel to each other; a plurality of washer-shaped insulating center spacers 130 maintained at a constant distance between adjacent insulating cooling plates 110; a plurality of pancake coils 620 including Litz wires which are spirally wound on each of the insulating center spacers 130 in a space between the adjacent insulating cooling plates 110; and a housing 140 which covers at least outer side surfaces of the insulating cooling plates 110 and the pancake coils 620 and provides a coolant to cool the insulating cooling plates 110. The Litz wires constituting the pancake coils 620 are in thermal contact with the adjacent insulating cooling plates 110. The coolant is provided in a cooling space 103, and the cooling space 103 is formed in a space which is not filled with the insulating center spacers 130 and the pancake coils 620 in a space between the adjacent insulating cooling plates 110.

The pancake coils 620a to 620i may be sequentially and vertically stacked at regular intervals. At least two adjacent pancake coils 620a and 620b constitute a pancake coil bundle 621a. The pancake coils 620a and 620b constituting the pancake coil bundle 621a are connected in parallel to each other. Among pancake bundles, the lowermost pancake bundle 621a includes a first connection terminal 121 for electrical connection with an external power supply and the uppermost pancake coil bundle 621d includes a second connection terminal 122 for electrical connection with the external power supply. The pancake coil bundles 621a to 621d may be sequentially connected in series to each other according to layer height. Directions in which Litz wires of pancake coils constituting the pancake coil bundles 621a to 621d are wound may be alternately opposite to each other according to height of the pancake coil bundle.

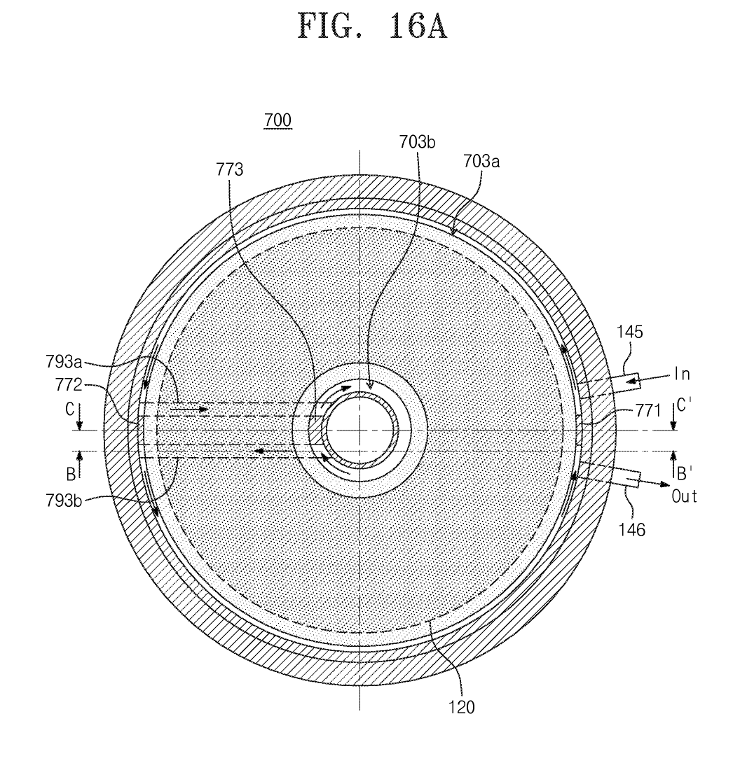

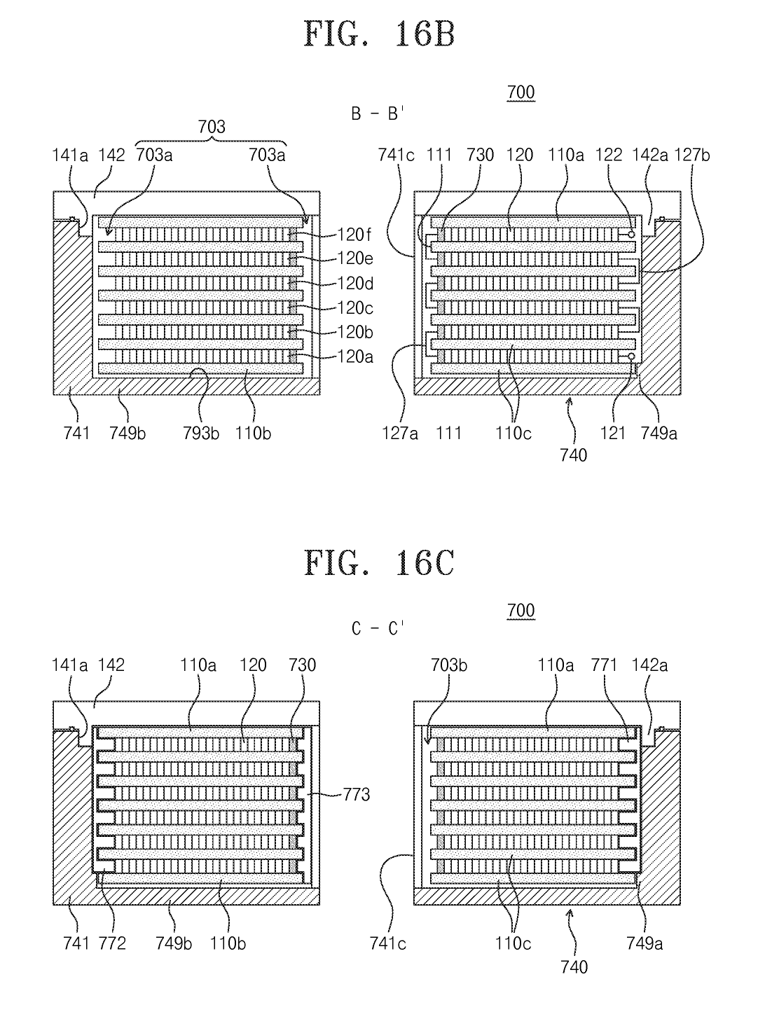

FIG. 16A is a top plan view of an electromagnet according to another example embodiment of the present disclosure.

FIG. 16B is a cross-sectional view taken along the line B-B′ in FIG. 16A.

FIG. 16C is a cross-sectional view taken along the line C-C′ in FIG. 16A.

Referring to FIGS. 16A through 16C, an electromagnet 700 includes a plurality of insulating cooling plates 110 of a ceramic material which are vertically arranged parallel to each other; a plurality of washer-shaped insulating center spacers 730 maintained at a constant distance between adjacent insulating cooling plates 110; a plurality of pancake coils 120 including Litz wires which are spirally wound on each of the insulating center spacers 730 in a space between the adjacent insulating cooling plates 110; and a housing 740 which covers at least outer side surfaces of the insulating cooling plates 110 and the pancake coils 120 and provides a coolant to cool the insulating cooling plates 110. The Litz wires constituting the pancake coils 120 are in thermal contact with the adjacent insulating cooling plates 110. The coolant is provided in a cooling space 703, and the cooling space 703 is formed in a space which is not filled with the insulating center spacers 730 and the pancake coils 120 in a space between the adjacent insulating cooling plates 110.

Each of the insulating cooling plates 110 has a through-hole in its center, the insulating center spacers 730 has a circular washer shape, and an inner diameter of each of the insulating center spacers 730 may be greater than a diameter of the through-hole 111 of each of the insulating cooling plates 110. The insulating center spacers 730 may be inserted between the adjacent insulating cooling plates 110 to be fixed. Thus, the insulating cooling plates 110 may be more protrusive inwardly than the insulating center spacers 730. An outer diameter of the insulating cooling plate 110 may be greater than that of the pancake coil 120.

The cooling space 703 may include a first cooling space 703a formed at an outermost position between adjacent cooling plates 110 and a second cooling space 703b formed at an innermost position between the adjacent cooling plates 110. The housing 740 may be in the form of a hollow toroid having a square section.

The housing 740 may include a coolant inlet which connects the cooling space 703 with the outside of the housing 740 through an outer side surface of the housing 740, a coolant outlet 146 which connects the cooling space 703 with the outside of the housing 740 through the outer side surface of the housing 740, a first separator 771 which barricades the space between the coolant inlet 145 and the coolant outlet 146 in a first cooling space 703a, first and second flow passages 793a and 793b formed on the inner surface of the bottom of the housing 740 to be adjacent to each other in a radial direction to connect the first cooling space 703a with a second cooling space 703b, a second separator 772 which locally barricades the first cooling space 703a, and a third separator 773 which locally barricades the second cooling space 703b such that a coolant flows into the first flow passage 793a to flow out to the second flow passage 703b.

The housing 740 may include a housing body portion 741 which includes a washer-shaped bottom support 749b disposed on its bottom surface and stores the pancake coils 120, a housing cover portion 142 which has a circular washer shape and is disposed to cover a top surface of the housing body portion 741, and a cylindrical inner body portion 741c which connects an inner radius of the bottom support 749a and an inner radius of the housing cover portion 142 to each other. An alignment protrusion 749a may be disposed at a coupling portion of the bottom support 749b and the housing body portion 741. The lowermost insulating cooling plate may be aligned with the alignment protrusion 749a. The alignment protrusion 749a may have a ring shape but may also be locally removed in a region in which the first flow passage 793a and the second flow passage 793b are formed. The first and the second flow passages 793a and 793b may extend in a radial direction and may be trenches formed on the top surface of the bottom support 749b.

The outer side and the inner side of an insulating cooling plates disposed in a toroid-shaped storage space may provide a first cooling space 703a and a second cooling space 703b, respectively. The inner diameter of the insulating cooling plates 110 may be smaller than that of the insulating center spacers 730. Thus, outer top and bottom surfaces of the insulating cooling plate 110 may inwardly protrude to be cooled by a coolant.

The coolant may flow along a portion of the first cooling space 703a, the first flow passage 793a, the second cooling space 703b, the second flow passage 793b, and the other portion of the first cooling space 703a. The first separator 771 and the second separator 772 may be disposed to face each other at a difference of 180 degrees on the basis of the center of the housing 740. The third separator 773 may be disposed to face the second separator 772. Thus, the coolant may travel the first cooling space 703a 180 degrees counterclockwise, travel along the first flow passage 793a in radially inward direction, travel along the second cooling space 703b about 360 degrees clockwise, travel along the second flow passage 793b in radially outward direction, and travel along the first cooling space 703a 180 degrees counterclockwise.

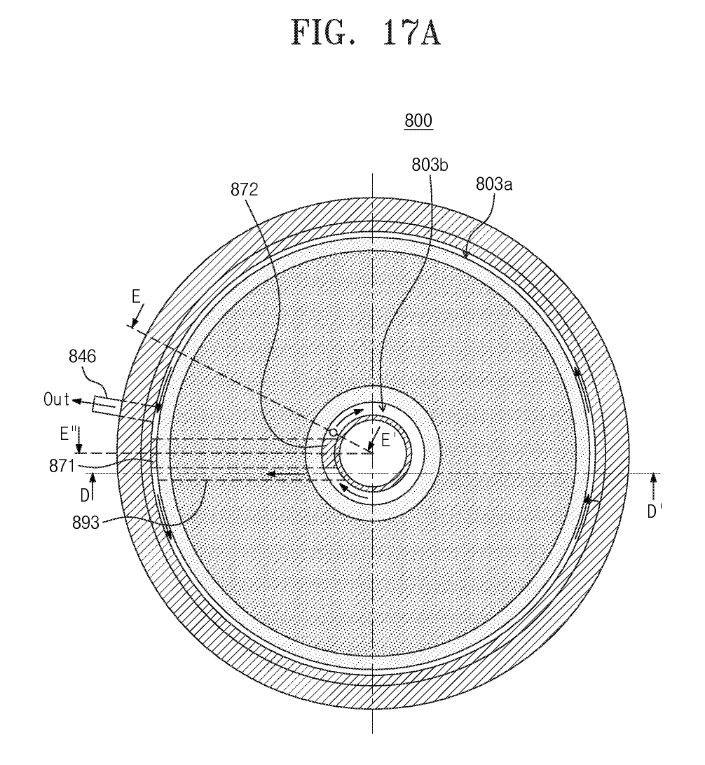

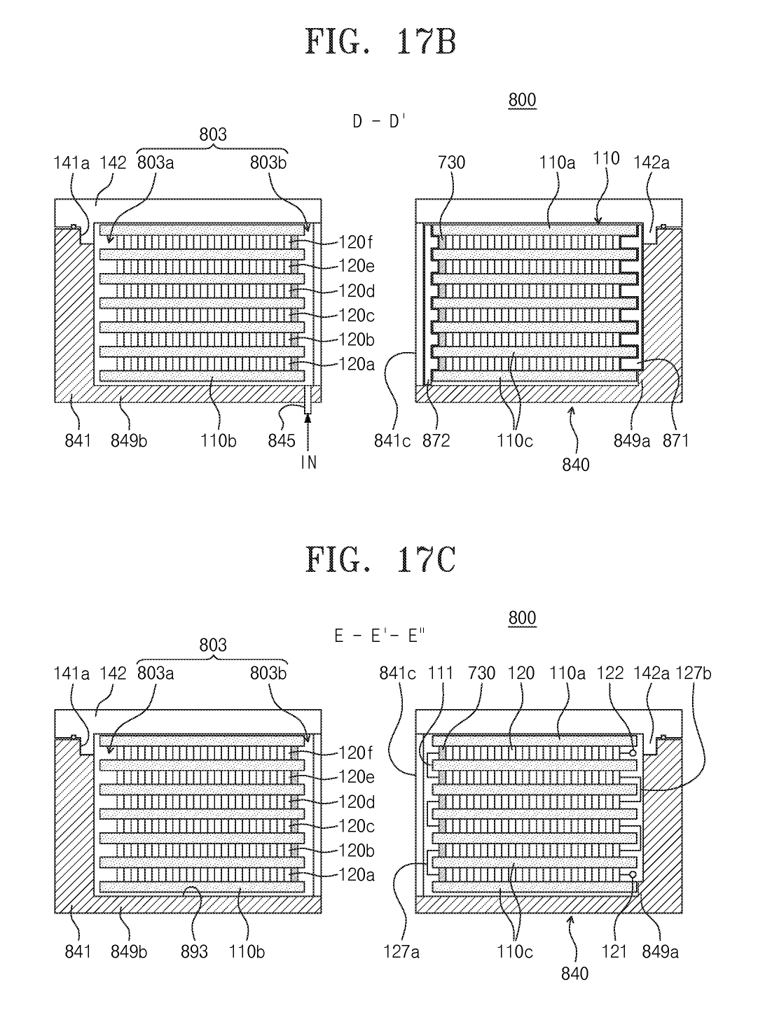

FIG. 17A is a top plan view of an electromagnet according to another example embodiment of the present disclosure.

FIG. 17B is a cross-sectional view taken along the line D-D′ in FIG. 17A.

FIG. 17C is a cross-sectional view taken along the line E-E′-E″ in FIG. 17A.

Referring to FIGS. 17A through 17E, an electromagnet 800 includes a plurality of insulating cooling plates 110 of a ceramic material which are vertically arranged parallel to each other; a plurality of washer-shaped insulating center spacers 730 maintained at a constant distance between adjacent insulating cooling plates 110; a plurality of pancake coils 120 including Litz wires which are spirally wound on each of the insulating center spacers 730 in a space between the adjacent insulating cooling plates 110; and a housing 840 which covers at least outer side surfaces of the insulating cooling plates 110 and the pancake coils 120 and provides a coolant to cool the insulating cooling plates 110. The Litz wires constituting the pancake coils 120 are in thermal contact with the adjacent insulating cooling plates 110. The coolant is provided in a cooling space 803, and the cooling space 803 is formed in a space which is not filled with the insulating center spacers 730 and the pancake coils 120 in a space between the adjacent insulating cooling plates 110.

Each of the insulating cooling plates 110 may have a through-hole 111 formed on its center, each of the insulating center spacers 730 may have a circular washer shape, and the inner diameter of the insulating center spacers 730 may be greater than the diameter of the through-holes 111 of the insulating cooling plates 110. The insulating center spacers 730 may be inserted between the adjacent insulating cooling plates 110 to be fixed. Thus, the insulating cooling plates 110 may be more protrusive inwardly than the insulating center spacers 730. The outer diameter of the insulating cooling plates 110 may be greater than that of the pancake coils 120.

The cooling space 803 may include a first cooling space 803a formed at an outermost position between adjacent insulating cooling plates 110 and a second cooling space 803b formed at an innermost position between the adjacent insulating cooling plates 110. The housing 840 may be in the form of a hollow toroid having a square section.

The housing 840 includes a cooling inlet 845 which connects the second cooling space 803b with the outside of the housing 840 through a bottom surface of the housing 840, a cooling outlet 846 which connects the first cooling space 803a with the outside of the housing 840 through an outer side surface of the housing 840, a first separator 871 which locally barricades the first cooling space 803a, a flow passage 893 which is formed on the inner surface of the bottom of the housing 840 in a radial direction to connect the first cooling spaces 803a with the second cooling space 803b, and a second separator 872 which locally barricades the second cooling space 803b. The coolant may flow along the second cooling space 803b, the flow passage 893, and the first cooling space 803a. The flow passage 893 may be a trench formed in a radial direction of the bottom support 849b.

The housing 840 may include a cylindrical housing body portion 841 which includes a circular washer-shaped bottom support 849b disposed on its bottom surface and stores the insulating cooling plates 110 and the pancake coils 120, a housing cover portion 142 which has a circular washer shape and is disposed to cover the top surface of the housing body portion 841, and an inner body portion 841c which an inner radius of the bottom support 849b and an inner radius of the housing cover portion 142 to each other. An alignment protrusion 849a may be disposed at a coupling portion of the bottom support 849b and the housing body portion 841. The lowermost insulating cooling plate may be aligned with the alignment protrusion 849a. The alignment protrusion 849a may have a ring shape but be locally removed in a region in which the flow passage 893 is formed.

The outer side and the inner side of an insulating cooling plate 110 disposed in a toroid-shaped storage space of the housing 840 may provide the first cooling space 803a and the second cooling space 803b, respectively.

The coolant may travel along the second cooling space 803b about 360 degrees clockwise, travel along the flow passage 893 in radially outward direction, and travel along the first cooling space 803a about 360 degrees counterclockwise.

An electromagnet according to an example embodiment of the present disclosure includes insulating cooling plates which are bonded to opposite side surfaces of a pancake coil in order to withstand an induced electromotive force of a high voltage generated when a current is applied to the pancake coil and is removed, to effectively cool heat generated in the pancake coil, and in order to eliminate thermal noise using Litz wire.

An electromagnet according to an example embodiment of the present disclosure circulates a coolant (e.g., water, mineral oil, silicone oil, a fluoride compound or the like) while maintaining a constant speed and a constant temperature using an external pump and a heat exchanger. Thus, a pre-polarization magnetic field may be generated without any limitation in time while an inner temperature of a coil is maintained in a stable state.

Although the present disclosure and its advantages have been described in detail, it should be understood that various changes, substitutions and alterations can be made herein without departing from the spirit and scope of the disclosure as defined by the following claims.

What is claimed is:

1. An electromagnet comprising:
a plurality of insulating cooling plates of a ceramic material which are vertically arranged parallel to each other;
a plurality of washer-shaped insulating center spacers maintained at a constant distance between adjacent insulating cooling plates;
a plurality of pancake coils including Litz wires which are spirally wound on each of the insulating center spacers in a space between the adjacent insulating cooling plates; and
a housing which covers at least outer side surfaces of the insulating cooling plates and the pancake coils and provides a coolant to cool the insulating cooling plates,
wherein the Litz wires constituting the pancake coils are in thermal contact with the adjacent insulating cooling plates,
wherein the coolant is provided in a cooling space, and
wherein the cooling space is formed in a space which is not filled with the insulating center spacers and the pancake coils in a space between the adjacent insulating cooling plates.

2. The electromagnet as set forth in claim 1, wherein
each of the pancake coils includes a plurality of unit pancake coils stacked to be aligned with each other,
each of the unit pancake coils is spirally wound on a same plane,
directions in which the unit pancake coils are wound are identical to each other in a same pancake coil,
the unit pancake coils are electrically connected in parallel in a same pancake coil, and
the adjacent unit pancake coils are in thermal contact with each other.

3. The electromagnet as set forth in claim 1, wherein
among the pancake coils, a lowermost pancake coil includes a first connection terminal for electrical connection with an external power supply,
among the pancake coils, an uppermost pancake coil includes a second connection terminal for electrical connection with the external power supply,
the pancake coils are connected in series to each other according to layer height, and
directions in which Litz wires constituting the pancake coils are wound are alternately opposite to each other according to layer height of the pancake coils.

4. The electromagnet as set forth in claim 1, wherein
at least two adjacent pancake coils constitute a pancake coil bundle,
pancake coils constituting each of the pancake coil bundles are connected in parallel to each other,
among the pancake coil bundles, a lowermost pancake coil bundle includes a first connection terminal disposed at one of its opposite ends for electrical connection with an external power supply,
among the pancake coil bundles, an uppermost pancake coil bundle includes a second connection terminal disposed at one of its opposite ends for electrical connection with the external power supply,
the pancake coil bundles are sequentially connected in series to each other according to layer height, and
directions in which Litz wires of the pancake coils constituting the pancake coil bundles are wound are alternately opposite to each other according to layer height.

5. The electromagnet as set forth in claim 1, wherein
the cooling space is formed between adjacent insulating cooling plates at their outermost positions,
outer diameters of the insulating cooling plates are greater than those of the pancake coils, and
the housing comprises:
a cylindrical housing body portion which includes a washer-shaped bottom support disposed on its bottom surface and stores the insulating cooling plates and the pancake coils;
a housing cover portion which has a circular washer shape and is disposed to cover a top surface of the housing body portion;
a coolant inlet which connects the cooling space with an outside of the housing through one of a side surface, bottom surface, and top surface of the housing body portion;
a coolant outlet which connects the cooling space with the outside of the housing through one of the side surface, the bottom surface, and the top surface of the housing body portion; and
a separator which barricades space between the coolant inlet and the coolant outlet in the cooling space.

6. The electromagnet as set forth in claim 5, wherein
each of the insulating cooling plates has a through-hole formed in its center, and
the insulating center spacers are inserted between through-holes of adjacent insulating cooling plates to be fixed, respectively.

7. The electromagnet as set forth in claim 5, wherein
an alignment protrusion is provided between the bottom support and lower inner surface of the housing body portion .

8. The electromagnet as set forth in claim 1, wherein
a number of the pancake coils is odd,
among the pancake coils, a lowermost pancake includes a first connection terminal for electrical connection with an external power supply,
among the pancake coils, the uppermost pancake coil includes a second connection terminal for electrical connection with the external power supply,
the pancake coils are connected in series to each other according to layer height,
directions in which Litz wires constituting the pancake coils are wound are opposite to each other according to layer height of the pancake coils,
one of the first and the second connection terminals is disposed to pass through the insulating center spacer, and
the other of the first and the second connection terminals is disposed to penetrate the housing.

9. The electromagnet as set forth in claim 1, wherein
the cooling space is formed between adjacent insulating cooling plates at their outermost positions,
outer diameters of the insulating cooling plates are greater than those of the pancake coils, and
the housing comprises:
a cylindrical housing body portion which includes a disk-shaped bottom support disposed on its bottom surface and stores the insulating cooling plates and the pancake coils;
a housing cover portion which has a disk shape and is disposed to cover the top surface of the housing body portion;
a coolant inlet which connects the cooling space with an outside of the housing through one of the side surface, the bottom surface, and the top surface of the housing body portion;
a coolant outlet which connects the cooling space with the outside of the housing through one of the side surface, the bottom surface, and the top surface of the housing body portion; and
a separator which barricades the space between the coolant inlet and the coolant outlet in the cooling space.

10. The electromagnet as set forth in claim 9, wherein
the insulating cooling plates include disk-shaped first insulating cooling plates and circular washer-shaped second insulating cooling plates each having a through-hole formed in its center,
the first insulating cooling plates and the second insulating cooling plates are alternately disposed according to layer height, and
the first insulating cooling plates are disposed on the uppermost surface and a lowermost surface.

11. The electromagnet as set forth in claim 1, wherein
each of the insulating cooling plates has a through-hole formed in its center,
each of the insulating center spacers has a circular washer shape,
an inner diameter of the insulating spacers is greater than a diameter of the through-holes of the insulating cooling plates,
an outer diameter of the insulating cooling plates is greater than that of the pancake coils,
the cooling space includes a first cooling space formed between adjacent insulating cooling plates at their outermost positions and a second cooling space formed between the adjacent insulating cooling plates at their innermost positions,
the housing is in a form of a hollow toroid having a square section,
the housing comprises:
a coolant inlet which connects the cooling space with an outside of the housing through one of the outer side surface, the bottom surface, and the top surface of the housing;
a coolant outlet which connects the cooling space with the outside of the housing through one of the outer side surface, the bottom surface, and the top surface of the housing;
a first separator which barricades space between the coolant inlet and the coolant outlet;
first and second flow passages which are formed on the bottom surface of the housing to be adjacent to each other in a radial direction to connect the first cooling space and the second cooling space to each other;
a second separator which locally barricades the first cooling space; and
a third separator which locally barricades the second cooling space such that a coolant can flow into the first flow passage to flow out of the second flow passage, and
the coolant can flow along a portion of the first cooling space, the first flow passage, the second cooling space, the second flow passage, and the other portion of the first cooling space.

12. The electromagnet as set forth in claim 1, wherein
each of the insulating cooling plates has a through-hole formed in its center,
each of the insulating center spacers has a circular washer shape,
an inner diameter of the insulating center spacers is greater than a diameter of the through-holes of the insulating cooling plates,
an outer diameter of the insulating cooling plates is greater than that of the pancake coils,
the cooling space includes a first cooling space formed between adjacent insulating cooling plates at their outermost positions and a second cooling space formed between the adjacent insulating plates at their innermost positions,
the housing is in a form of a hollow toroid having a square section,
the housing comprises:
a coolant inlet which connects the second cooling space with an outside of the housing through the bottom surface of the housing;
a coolant outlet which connects the second cooling space with the outside of the housing through the bottom surface of the housing through one of the outer side surface, the bottom surface, and the top surface of the housing;
a first separator which locally barricades the first cooling space;
a flow passage which is formed on the inner surface of the bottom of the housing in a radial direction to connect the first cooling space and the second cooling space to each other; and
a second separator which locally barricades the second cooling space, and
the coolant can flow along the second cooling space, the flow passage, and the first cooling space.

13. The electromagnet as set forth in claim 1, wherein
the material of the insulating cooling plates includes at least one of aluminum nitride (AlN), alumina (Al₂O₃), boron nitride (BN), silicon nitride (Si₃N₄), and beryllium oxide (BeO).

14. An electromagnet comprising:
a plurality of insulating cooling plates of a ceramic material which are vertically arranged parallel to each other;
a plurality of washer-shaped insulating center spacers which are formed of a non-metal material and are maintained at a constant distance between adjacent insulating cooling plates;
a plurality of pancake coils including Litz wires which are spirally wound on each of the insulating center spacers in a space between the adjacent insulating cooling plates; and
a housing which stores the insulating cooling plates and the pancake coils and provides a coolant to cool the insulating cooling plates,
wherein the pancake coils are in thermal contact with the adjacent insulating cooling plates,
wherein the coolant is provided in a cooling space in which the insulating cooling plates are exposed, and
wherein the cooling space is formed in the space between the adjacent insulating cooling plates not filled with the insulating center spacers and the pancake coils.

15. An electromagnet comprising:
a plurality of insulating cooling plates of a ceramic material which are vertically arranged parallel to each other;
a plurality of washer-shaped insulating center spacers maintained at a constant distance between adjacent insulating cooling plates;
a plurality of pancake coils including Litz wires which are spirally wound on each of the insulating center spacers in the space between the adjacent insulating cooling plates; and
a housing which is in a form of a toroid having a square section, stores the insulating cooling plates and the pancake coils, and provides a coolant to cool the insulating cooling plates,
wherein the Litz wires constituting the pancake coils are in thermal contact with the adjacent insulating cooling plates, and
wherein the coolant is provided in a cooling space.
